(19) United States
(12) Patent Application Publication
(10) Pub. No.: US 2007/0120089 A1
(43) Pub. Date: May 31, 2007

(54) Polymer etchant and method of using same

(75) Inventors: Guoping Mao, Woodbury, MN (US); Rui Yang, Austin, TX (US); Lizhang Yang, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/288,914

(22) Filed: Nov. 28, 2005

(51) Int. Cl. C09K 13/00

(52) U.S. Cl. 252/79.1

(57) ABSTRACT

Provided is a composition comprising: an aqueous solution for etching a polymeric material comprising from about 30 wt. % to about 55 wt. % of an alkali metal salt; from about 10 wt. % to about 35 wt. % of a solubilizer dissolved in said solution; and from about 3 wt. % to about 30 wt. % ethylene glycol dissolved in said solution. Also provided is a process comprising: providing a polymeric film; contacting said polymeric film with an aqueous solution comprising from about 30 wt. % to about 55 wt. % of an alkali metal salt; from about 10 wt. % to about 35 wt. % of a solubilizer dissolved in said solution; and from about 3 wt. % to about 30 wt. % ethylene glycol dissolved in said solution.

### TECHNICAL FIELD

This invention relates to chemically etching of polymers.

### BACKGROUND

An etched copper or printed conductive circuit pattern on a polymer film base may be referred to as a flexible circuit or flexible printed wiring board. As the name suggests, flexible circuitry can move, bend and twist without damaging the conductors to permit conformity to different shapes and unique package sizes. Originally designed to replace bulky wiring harnesses, flexible circuitry is often the only solution for the miniaturization and movement needed for current, cutting-edge electronic assemblies. Thin, lightweight and ideal for complicated devices, flexible circuit design solutions range from single-sided conductive paths to complex, multilayer three-dimensional packages. A multilayer flexible circuit is a combination of two or more layers of single or double-sided flexible circuits laminated together and processed with laser drilling and plating to form plated through-holes. This creates conductive paths between the various layers without having to use multiple soldering operations.

Areas such as medical diagnostics, forensics, genomics, environmental monitoring, and contaminant testing often require routine repetitive testing for detection and identification of chemical compounds. Frequently, parallel screening methodologies are used to analyze the large volume of samples in these various fields. Despite improvements in parallel screening methods and other technological advances, such as robotics and high throughput detection systems, current screening methods still have a number of associated problems. For example, screening large numbers of samples using existing parallel screening methods have large space requirements to accommodate the samples and equipment, e.g., robotics, high costs associated with equipment and non-reusable supplies, and high reagent requirements necessary for performing the assays.

Available reaction volumes are often very small due to limited availability of the compound to be identified. Such small volumes lead to errors associated with fluid handling and measurement, e.g., due to evaporation, dispensing errors, and the like. Additionally, fluid-handling equipment and methods are typically unable to handle these small volumes with acceptable accuracy. The shortcomings of standard analysis techniques are promoting development efforts in the area of microfluidic analysis.

Since the mid 90's researchers have been working on methods to miniaturize complex laboratory analysis systems down to a size that would make them portable. These miniaturized chemical analysis systems are called “lab on a chip”.

These miniaturized analysis systems have many advantages over existing large-scale laboratory equipment. Primarily, portability, physical size, simple operation, and low cost allow hand held equipment to be transported with ease to the location where the information is required and to the source of the analyte. The markets in which this technology would be most useful include medical diagnostics, forensics, agriculture, infectious disease control, environmental monitoring, homeland security, and military applications. Several other areas would also benefit from more efficient laboratory analysis such as analytical chemistry, chemical synthesis, cell biology, molecular biology, drug discovery, genomics, proteomics, and diagnostics.

These lab on a chip systems contain one or more of the following elements: one or more electrodes; reservoirs for buffer solutions, waste, reagents and other fluids; reaction chambers (e.g., immuno-reaction chamber); channels for fluid separation or delivery; capillary electrophoresis structures; heaters; and optical interfaces.

### SUMMARY

One aspect of the present invention provides a composition comprising: an aqueous solution for etching polymeric material comprising from about 30 wt. % to about 55 wt. % of an alkali metal salt; from about 10 wt. % to about 35 wt. % of a solubilizer dissolved in said solution; and from about 3 wt. % to about 30 wt. % ethylene glycol.

Another aspect of the present invention provides an article comprising: a flexible circuit comprising a polymeric film having through-holes and related shaped voids formed therein using an etchant composition comprising: an aqueous solution for etching polymeric material comprising from about 30 wt. % to about 55 wt. % of an alkali metal salt; from about 10 wt. % to about 35 wt. % of a solubilizer dissolved in said solution; and from about 3 wt. % to about 30 wt. % ethylene glycol.

Another aspect of the present invention provides a process comprising: providing a polymeric film; contacting said polymeric film with an aqueous solution comprising from about 30 wt. % to about 55 wt. % of an alkali metal salt; from about 10 wt. % to about 35 wt. % of a solubilizer dissolved in said solution; and from about 3 wt. % to about 30 wt. % ethylene glycol.

An advantage of at least one embodiment of the present invention is that the ethylene glycol in the etchant provides increased resist stability and increased etching rates. It also helps stabilize the etchant formulation at low temperatures (e.g., 0° C.) without precipitation.

Other features and advantages of the invention will be apparent from the following drawings, detailed description, and claims.

### BRIEF DESCRIPTION OF DRAWINGS

FIG. 1 is a digital image of a pocket etched in a polycarbonate film with a prior art etchant.

FIG. 2 is a digital image of a pocket etched in a polycarbonate film with an etchant of the present invention.

FIG. 3 is a digital image of a pocket etched in a polycarbonate film with an etchant of the present invention.

As used herein all amounts included as percentages refer to weight percent of a designated component.

### DETAILED DESCRIPTION

As required, details of the present invention are disclosed herein; however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present invention.

The present invention provides an etchant suitable for use with polymer films that are used in application such as flexible circuit substrates, microfluidic devices, and carrier films with pockets. Substrates for composite flexible circuits typically include a flexible polymer substrate film and copper conductive traces. (Conductive traces may also be gold, nickel or silver.) Specific flexible circuit applications include, lap top computers, personal digital assistants, cell phones, calculators, cameras, plasma televisions, and any device that has a display with an interface that bends or folds. Substrates for microfluidic devices that include a flexible polymer substrate film having indentions or regions of controlled depth and optionally copper conductive traces. Formation of indentations, also referred to herein as recesses, channels, trenches, wells, reservoirs, reaction chambers, and the like, creates changes of thickness in areas of the polymer films. Substrates for carrier pocket tapes for electronic components may require complex three-dimensional shapes to be etched into thick films, typically polycarbonate films.

Materials

Polymer films of the present invention may be polycarbonates, liquid crystal polymers, polyimides, including polyimide polymers having carboxylic ester units in the polymeric backbone, polyesters, polyamide-imide, and other suitable polymeric materials. Preferably, the film being etched is substantially fully cured.

Etching of films to introduce precisely-shaped voids, recesses and other regions of controlled thickness requires the use of a film that does not swell in the presence of alkaline etchant solutions. Swelling changes the thickness of the film and may cause localized delamination of resist. This can lead to loss of control of etched film thickness and irregular shaped features due to etchant migration into the delaminated areas. Controlled etching of films, according to the present invention, is most successful with substantially non-swelling polymers. “Substantially non-swelling” refers to a film that swells by such an insignificant amount when exposed to an alkaline etchant as to not hinder the thickness-reducing action of the etching process. For example, when exposed to some etchant solutions, some polyimide will swell to such an extent that their thickness cannot be effectively controlled in reduction. Polyimides such as APICAL HPNF, which has a carboxylic ester structural units in the polymeric backbone, is particularly suitable when etching only part way through the thickness of the polymer layer is desired. This is because polyimides with carboxylic ester structural units in the polymeric backbone do not swell in alkaline etchant solutions, as do other polyimides. However, if an opening is to be etched completely through the polymeric film, swelling of the polymeric material is less important because a change in thickness of the material being etched will have a lesser impact on the resulting structure.

Etchant

Water soluble salts suitable for use in a highly alkaline etchant include, for example, potassium hydroxide (KOH), sodium hydroxide (NaOH), substituted ammonium hydroxides, such as tetramethylammonium hydroxide and ammonium hydroxide or mixtures thereof. Useful alkaline etchants include aqueous solutions of alkali metal salts including alkali metal hydroxides, particularly potassium hydroxide, and their mixtures with amines, as described in U.S. Pat. Nos. 6,611,046 B1 and 6,403,211 B 1. Useful concentrations of the etchant solutions vary depending upon the thickness of the polymeric film to be etched, as well as the type (e.g., metal mask or photoresist) and thickness of the photoresist, if it is used. Typical concentrations of a suitable salt have lower values of about 30 wt. % to about 40 wt % and upper values of about 50 wt % to about 55 wt. %. Typical concentrations of a suitable solubilizer have lower values of about 10 wt. % to about 15 wt. % and upper values of about 30 wt. % to 35 wt. %. The use of KOH with a solubilizer is often preferred for producing a highly alkaline solution because KOH-containing etchants can provide optimally etched features in the shortest amount of time. The etching solution is generally at a temperature of from about 50° C. (122° F.) to about 120° C. (248° F.) preferably from about 700° C. (160° F.) to about 95° C. (200° F.) during etching.

Typically the solubilizer in the etchant solution is an amine compound, such as an alkanolamine. Solubilizers for etchant solutions may be selected from the group consisting of amines, including ethylene diamine, propylene diamine, ethylamine, methylethylamine, and alkanolamines such as ethanolamine, diethanolamine, propanolamine, and the like.

The typical concentration of ethylene glycol is between about 3 wt. % and about 30 wt %. In at least one embodiment the concentration is about 7 wt. %. In another embodiment the concentration in below 12 wt. %. Ethylene glycol may also be used at concentrations above about 30 wt. %. However, higher concentrations of ethylene glycol will necessarily result in lower concentrations of water or alkali metal salt (e.g., KOH). A reduction in the alkali metal salt concentration can decrease the etching rate of the etchant.

The presence of ethylene glycol in the etchant provides several advantages. For example, a reduction in photoresist undercut is achieved. “Undercut” is when the etchant etches the outer portions of a polymeric film that are covered by a photoresist. This can destabilize the resulting structure. With a reduction in undercut, smaller features can be produces in the polymeric material. In addition, the addition of ethylene glycol reduces the amount of photoresist swelling compared to etchants that do not contain ethylene glycol. This allows the etchant to be used on thicker polymeric materials, because the photoresist remains stable for longer periods of exposure to the etchant. For example, in etching to a depth of 100 um, an etchant solution without ethylene glycol might produce an undercut of 100 um. In contrast, an etchant solution without ethylene glycol might produce an undercut of only 35 um.

Due to the addition of the ethylene glycol, the etching solution may be used at temperatures as low as 0° C. This provides greater operating lattitude than with etchant solution that do not contain ethylene glycol, which are typically used at a temperature of from about 50° C (122° F.) to about 120° C. (248° F.).

Under the conditions of etching, unmasked areas of a polymer film substrate become soluble by action of the solubilizer in the presence of a sufficiently concentrated aqueous solution of, e.g., an alkali metal salt. The time required for etching depends upon the type and thickness of polymeric film to be etched, the composition of the etching solution, the etch temperature, spray pressure, and the desired depth of the etched region.

Polyimide

Polyimide film is a commonly used substrate for flexible circuits that fulfill the requirements of complex, cutting-edge electronic assemblies. The film has excellent properties such as thermal stability and low dielectric constant.

As described in U.S. Pat. No. 6,611,046 B1 it is possible to produce chemically etched vias and through holes in flexible polyimide circuits, as needed for electrical interconnection between the circuit and a printed circuit board. Most commercially available polyimide film comprises monomers of pyromellitic dianhydride (PMDA), or oxydianiline (ODA), or biphenyl dianhydride (BPDA), or phenylene diamine (PDA). Polyimide polymers including one or more of these monomers may be used to produce film products designated under the trade name KAPTON H, K, E films (available from E. I. du Pont de Nemours and Company, Circleville, Ohio) and APICAL AV, NP films (available from Kaneka Corporation, Otsu, Japan).

Another suitable polyimide film is APICAL HPNF polyimide film is believed to be a copolymer that derives its ester unit containing structure from polymerizing of monomers including p-phenylene bis(trimellitic acid monoester anhydride). Other ester unit containing polyimide polymers are not known commercially. However, to one of ordinary skill in the art, it would be reasonable to synthesize other ester unit containing polyimide polymers depending upon selection of monomers similar to those used for APICAL HPNF. Such syntheses could expand the range of polyimide polymers for films, which, like APICAL HPNF, may be controllably etched. Materials that may be selected to increase the number of ester containing polyimide polymers include 1,3-diphenol bis(anhydro-trimellitate), 1,4-diphenol bis(anhydro-trimellitate), ethylene glycol bis(anhydro-trimellitate), biphenol bis(anhydro-trimellitate), oxy-diphenol bis(anhydro-trimellitate), bis(4-hydroxyphenyl sulfide) bis(anhydro-trimellitate), bis(4-hydroxybenzophenone) bis(anhydro-trimellitate), bis(4-hydroxyphenyl sulfone) bis(anhydro-trimellitate), bis(hydroxyphenoxybenzene), bis(anhydro-trimellitate), 1,3-diphenol bis(aminobenzoate), 1,4-diphenol bis(aminobenzoate), ethylene glycol bis(aminobenzoate), biphenol bis(aminobenzoate), oxy-diphenol bis(aminobenzoate), bis(4 aminobenzoate) bis(aminobenzoate), and the like.

Liquid Crystal Polymers (LCP)

LCP films represent suitable materials as substrates for many applications including microfluidic devices and flexible circuits having improved high frequency performance, lower dielectric loss, and less moisture absorption than polyimide films. Characteristics of LCP films include electrical insulation, moisture absorption less than 0.5% at saturation, a coefficient of thermal expansion approaching that of the copper used for plated through holes, and a dielectric constant not to exceed 3.5 over the functional frequency range of 1 kHz to 45 GHz.

Suitable films of liquid crystal polymers comprise aromatic polyesters including copolymers containing p-phenyleneterephthalamide such as BIAC film (Japan Gore-Tex Inc., Okayama-Ken, Japan) and copolymers containing p-hydroxybenzoic acid such as LCP CT film (Kuraray Co., Ltd., Okayama, Japan).

Other suitable films include extruded and tentered (biaxially stretched) liquid crystal polymer films. A process development, described in U.S. Pat. No. 4,975,312, provided multiaxially (e.g., biaxially) oriented thermotropic polymer films of commercially available liquid crystal polymers (LCP) identified by the trade names VECTRA (naphthalene based, available from Hoechst Celanese Corp.) and XYDAR (biphenol based, available from Amoco Performance Products). Multiaxially oriented LCP films of this type represent suitable substrates for flexible printed circuits and circuit interconnects suitable for production of device assemblies such as microfluidic devices.

Polycarbonate

Characteristics of polycarbonate films include electrical insulation, moisture absorption less than 0.5% at saturation, a dielectric constant not to exceed 3.5 over the functional frequency range of 1 kHz to 45 GHz, better chemical resistance when compared to polyimide, lower modulus may enable more flexible circuits, and the optical clarity of polycarbonate films will allow the formation of microfluidic devices to be used in conjunction with a variety of spectrographic techniques in the ultraviolet and visible light domains. Polycarbonates also have lower water absorption than polyimide and lower dielectric dissipation. Polycarbonates can be readily etched when a solubilizer is combined with highly alkaline aqueous etchant solutions that comprise, for example, water soluble salts of alkali metals and ammonia.

Examples of suitable polycarbonate materials include substituted and unsubstituted polycarbonates; polycarbonate blends such as polycarbonate/aliphatic polyester blends, including the blends available under the trade name XYLEX from GE Plastics, Pittsfield, Mass., polycarbonate/polyethyleneterephthalate(PC/PET) blends, polycarbonate/polybutyleneterephthalate (PC/PBT) blends, and polycarbonate/poly(ethylene 2,6-naphthalate) ((PPC/PBT, PC/PEN) blends, and any other blend of polycarbonate with a thermoplastic resin; and polycarbonate copolymers such as polycarbonate/polyethyleneterephthalate(PC/PET) and polycarbonate/polyetherimide (PC/PEI).

Another type of material suitable for use in the present invention is a polycarbonate laminate. Such a laminate may have at least two different polycarbonate layers adjacent to each other or may have at least one polycarbonate layer adjacent to a thermoplastic material layer (e.g., LEXAN GS 125DL which is a polycarbonate/polyvinylidene fluoride (PVDF) laminate from GE Plastics). Polycarbonate materials may also be filled with carbon black, silica, alumina and the like or they may contain additives such as flame retardants, UV stabilizers, pigment and the like.

Other Polymers

Embodiments of etchants of the present invention can be used with any polymeric material for which the etchant provides a desirable etch rate and desirable result. Examples of other suitable polymers include polyesters such as polyethylene terephthalate (PET), amorphous PET, polyethylene naphthalate (PEN), polybutylene terephthalate (PBT); polyamide-imides, and the like.

Methods

Embodiments of etchants of the present invention are suitable for use with manufacturing techniques used in continuous web flexible circuit processing. This allows for the production of high volume, low cost substrates. Flexible circuitry is a solution for the miniaturization and movement needed for state-of-the-art electronic assemblies. Thin, lightweight and ideal for complicated devices, flexible circuit design solutions range from single-sided conductive paths to complex, multilayer three-dimensional packages.

The formation of recessed or thinned regions, channels, reservoirs, unsupported leads, through holes and other circuit features in the film typically requires protection of portions of the polymeric film using a mask of a photo-crosslinked negative acting, aqueous processable photoresist, or a metal mask. During the etching process the photoresist exhibits substantially no swelling or delamination from the polymer film.

While photoresist is commonly used as a mask for substrate etching to form polymer patterns or features, a metal also can be used. For example, a metal layer may be made by sputtering a thin layer of copper then plating additional copper to form a 1-5 μm thick layer. Photoresist is then applied to the metal layer, exposed to a pattern of radiation and developed to expose areas of the metal layer. The exposed areas of the metal layer are then etched to form a pattern. The remaining photoresist is then stripped off, leaving a metal mask. Metals other than copper may also be used as a mask. Electrolytic plating and electroless plating methods may be used to form the metal layer. Using metal masks instead of photoresist masks will typically result in increased sidewall etched angles and increased etched feature sizes.

Negative photoresists suitable for use with polymer films according to the present invention include negative acting, aqueous developable, photopolymer compositions such as those disclosed in U.S. Pat. Nos. 3,469,982; 3,448,098; 3,867,153; and 3,526,504. Such photoresists include at least a polymer matrix including crosslinkable monomers and a photoinitiator. Polymers typically used in photoresists include copolymers of methyl methacrylate, ethyl acrylate and acrylic acid, copolymers of styrene and maleic anhydride isobutyl ester and the like. Crosslinkable monomers may be multiacrylates such as trimethylol propane triacrylate.

Commercially available aqueous base, e.g., sodium carbonate developable, negative acting photoresists employed according to the present invention include polymethylmethacrylates photoresist materials such as those available under the trade name RISTON from E.I. duPont de Nemours and Co., e.g., RISTON 4720. Other useful examples include AP850 available from LeaRonal, Inc., Freeport, N.Y., and PHOTEC HU350 available from Hitachi Chemical Co. Ltd. Dry film photoresist compositions under the trade name AQUA MER are available from MacDermid, Waterbury, CT. There are several series of AQUA MER photoresists including the “SF” and “CF” series with SF120, SF125, and CF2.0 being representative of these materials.

In an exemplary flexible circuit manufacturing process, the polymer film of a polymer-metal laminate may be chemically etched at several stages. Introduction of an etching step early in the production sequence can be used to thin the bulk film or only selected areas of the film while leaving the bulk of the film at its original thickness. Alternatively, thinning of selected areas of the film later in the flexible circuit manufacturing process can have the benefit of introducing other circuit features before altering film thickness. Regardless of when selective substrate thinning occurs in the process, film-handling characteristics remain similar to those associated with the production of conventional flexible circuits.

A similar process is the manufacture of flexible circuits comprising the step of etching, which may be used in conjunction with various known pre-etching and post-etching procedures. The sequence of such procedures may be varied as desired for the particular application. A typical additive sequence of steps may be described as follows:
Aqueous processable photoresists are laminated over both sides of a substrate comprising polymer film with a thin copper side, using standard laminating techniques. Typically, the substrate has a polymeric film layer of from about 25 μm to about 75 μm, with the copper layer being from about 1 to about 5 μm thick. The thickness of the photoresist is from about 10 μm to about 50 μm. Upon imagewise exposure of both sides of the photoresist to ultraviolet light or the like, through a mask, the exposed portions of the photoresist become insoluble by crosslinking. The resist is then developed, by removal of unexposed polymer with a dilute aqueous solution, e.g., a 0.5-1.5% sodium carbonate solution, until desired patterns are obtained on both sides of the laminate. The copper side of the laminate is then further plated to desired thickness. Chemical etching of the polymer film then proceeds by placing the laminate in a bath of etchant solution, as previously described, at a temperature of from about 50° C. to about 120° C. to etch away portions of the polymer not covered by the crosslinked resist. This exposes certain areas of the original thin copper layer. The resist is then stripped from both sides of the laminate in a 2-5% solution of an alkali metal hydroxide at from about 25° C. to about 80° C., preferably from about 25° C. to about 60° C.
Subsequently, exposed portions of the original thin copper layer are etched using an etchant that does not harm the polymer film, e.g., PERMA ETCH, available from Electrochemicals, Inc.

In an alternate substractive process, the aqueous processable photoresists are again laminated onto both sides of a substrate having a polymer film side and a copper side, using standard laminating techniques. The substrate consists of a polymeric film layer about 25 μm to about 75 μm thick with the copper layer being from about 5 μm to about 40 μm thick. The photoresist is then exposed on both sides to ultraviolet light or the like, through a suitable mask, crosslinking the exposed portions of the resist. The image is then developed with a dilute aqueous solution until desired patterns are obtained on both sides of the laminate. The copper layer is then etched to obtain circuitry, and portions of the polymeric layer thus become exposed. An additional layer of aqueous photoresist is then laminated over the first resist on the copper side and crosslinked by flood exposure to a radiation source in order to protect exposed polymeric film surface (on the copper side) from further etching. Areas of the polymeric film (on the film side) not covered by the crosslinked resist are then etched with the etchant solution containing an alkali metal salt and solubilizer at a temperature of from about 70° C. to about 120° C., and the photoresists are then stripped from both sides with a dilute basic solution, as previously described.

It is possible to introduce regions of controlled thickness into the polymer film of the flexible circuit using controlled chemical etching either before or after the etching of through holes and related voids that completely removes polymer materials as required to introduce conductive pathways through the circuit film. The step of introducing standard voids in a printed circuit typically occurs about mid-way through the circuit manufacturing process. It is convenient to complete film etching in approximately the same time frame by including one step for etching all the way through the substrate and a second etching step for etching recessed regions of controlled depth. This may be accomplished by suitable use of photoresist, crosslinked to a selected pattern by exposure to ultraviolet radiation. Upon development, removal of photoresist reveals areas of polymer film that will be etched to introduce recessed regions.

Alternatively, recessed regions may be introduced into the polymer film as an additional step after completing other features of the flexible circuit. The additional step requires lamination of photoresist to both sides of the flexible circuit followed by exposure to crosslink the photoresist according to a selected pattern. Development of the photoresist, using the dilute solution of alkali metal carbonate described previously, exposes areas of the polymer film that will be etched to controlled depths to produce indentations and associated thinned regions of film. After allowing sufficient time to etch recesses of desired depth into the polymer substrate of the flexible circuit, the protective crosslinked photoresist is stripped as before, and the resulting circuit, including selectively thinned regions, is rinsed clean.

The process steps described above may be conducted as a batch process using individual steps or in automated fashion using equipment designed to transport a web material through the process sequence from a supply roll to a wind-up roll, which collects mass produced circuits that include selectively thinned regions and indentations of controlled depth in the polymer film. Automated processing uses a web handling device that has a variety of processing stations for applying, exposing and developing photoresist coatings, as well as etching and plating the metallic parts and etching the polymer film of the starting metal to polymer laminate. Etching stations include a number of spray bars with jet nozzles that spray etchant on the moving web to etch those parts of the web not protected by crosslinked photoresist.

Similar etching processes may be used to make microfluidic devices and pocket carrier tapes for the transportation of integrated circuits and other devices used in the manufacture of, for example, printed circuit boards.

### EXAMPLES

This invention is illustrated by the following examples, but the particular materials and amounts thereof recited in these examples, as well as other conditions and details should not be construed to unduly limit this invention.

Etchant Solutions

Etchants of varying concentrations were prepared. The general procedure for preparing the etchants included dissolving potassium hydroxide (KOH) in water (H₂O), followed by the addition of the ethylene glycol (EG), then the addition of ethanolamine (EA). For Etchant Examples VIII and IX, the KOH and water were mixed first, followed by the addition of EA then EG. Comparative etchant solutions containing no EG were prepared in a similar manner. Etchant compositions are provided in Table 1.

TABLE 1
Etchant Compositions

Etchant Composition
(wt %)

| Etchant Example | KOH | EA | EG | H₂O |
|---|---|---|---|---|
| I | 34.5 | 35.9 | 9.9 | 19.7 |
| II | 38.9 | 20.3 | 6.3 | 34.5 |
| III | 39.4 | 19.7 | 11.8 | 29.1 |
| IV | 39.5 | 18.8 | 6.0 | 35.7 |
| V | 40.2 | 19.5 | 6.6 | 33.8 |
| VI | 41.0 | 19.9 | 7.1 | 32.0 |
| VII | 42.1 | 18.7 | 6.5 | 32.7 |
| VIII | 42 | 19 | 6.5 | 32.5 |
| IX | 43.6 | 19 | 3 | 34.4 |
| A | 45 | 20 | — | 35.0 |
| B | 42 | 21 | — | 37.0 |
| C | 42 | 20 | — | 38.0 |
| D | 41 | 20 | — | 39.0 |
| E | 40 | 20 | — | 40.0 |

### Examples 1-4 and Comparative Example C1-C2

### Etching of Polycarbonate Films at 76° C.

Samples of 7 mil thick polycarbonate film available under the trade designation 8A35 and samples of a 10 mil thick polycarbonate film available under the trade designation T2F both from GE Plastics, Pittsfield, Mass., were etched from both sides of the film using different etchant compositions, in beakers placed in water baths at 76° C. without stirring. The etching rates and resist stability for the samples are shown in Table 2.

TABLE 2
Etching at 76° C.

| | | | Etching rate |
|---|---|---|---|
| | | | (micrometer/min |
| Ex. | Etchant | Polycarbonate Film | (um/min))* |
| C1 | E | 8A35 | 16.0 |
| 1 | I | 8A35 | 25.8 |
| 2 | III | 8A35 | 24.0 |
| 3 | IV | 8A35 | 25.8 |
| C2 | E | T2F | 14.6 |
| 4 | IV | T2F | 27.6 |

*Etching rate measurement is based on a total etching time of about 4.5 minutes.

### Examples 5-7 and Comparative Examples C3

### Etching of Polycarbonate Films at 96° C.

Samples of 7 mil thick polycarbonate film available under the trade designation 8A35 from General Electric were etched from both sides of the film using different etchant compositions, in breakers placed in water baths at 96° C. without stirring. The etching rates and resist stability for the samples are shown in Table 3.

TABLE 3
Etching at 96° C.

| Ex. | Etchant | Etching Rate (um/min)* |
|---|---|---|
| C3 | E | 44 |
| 5 | I | 74 |
| 6 | III | 61 |
| 7 | VI | 67 |

*Etching rate measurement is based on a total etching time of about 1 minutes.

### Examples 8-16 and C4-C6

### Different Etching Times

Samples of 7 mil thick polycarbonate film available under the trade designation 8A35 from General Electric were etched from both sides of the film using different etchant compositions, and for different lengths of time, in beakers placed in water baths at 86° C. without stirring. The etching rates for the samples are shown in Table 4.

TABLE 4
Different Etching times

| | | | Etching |
|---|---|---|---|
| Ex. | Etchant | Etching Time (min) | rate (um/min)* |
| C4 | E | 1 | 27.0 |
| 8 | I | 1 | 59.0 |
| 9 | III | 1 | 39.0 |
| 10 | IV | 1 | 45.0 |
| C5 | E | 2 | 25.5 |
| 11 | I | 2 | 48.5 |
| 12 | III | 2 | 39.5 |
| 13 | IV | 2 | 44.0 |
| C6 | E | 4 | 26.0 |
| 14 | I | 4 | 33.3 |
| 15 | III | 4 | 34.0 |
| 16 | IV | 4 | 34.9 |

### Example 17-21 and C7

### Determining Undercut

Three samples of 7 mil polycarbonate film available under the trade designation 8B35 from General Electric were laminated with photoresist on both sides. For each sample, one of the resist layers was exposed under a mask and developed, while the other layer resist was flood exposed. The exposed portions of the samples were etched from using different etchant compositions, and for different lengths of time, as shown in Table 5, in beakers placed in water baths at 85° C. without stirring. The remaining resist was then stripped (using 5% KOH solution) and the etched features were visually evaluated using an optical microscope.

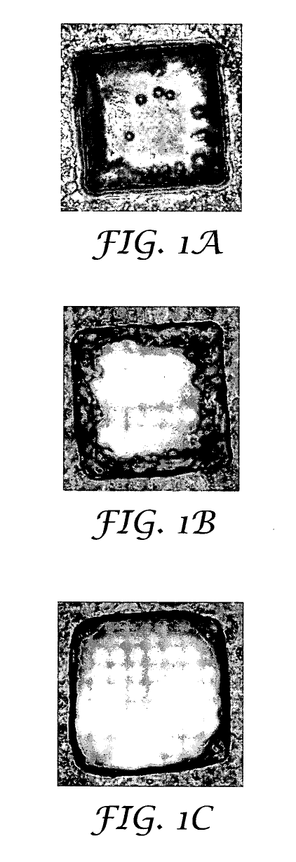

With Etchant E, resist undercut was very obvious as is shown in FIG. 1A. In contrast, Etchant V resulted in almost no undercut as shown in FIGS. 1B and 1C.

TABLE 5
Undercut

| | | | Mask size | | |
|---|---|---|---|---|---|
| | | Etching Time | (micrometer | Pocket size | Undercut |
| Ex. | Etchant | (min) | (um)) | (um) | (um) |
| C7 | E | 10 | 700 | 905* | 35 |
| 17 | V | 10 | 750 | 908 | minimal |
| 18 | V | 10 | 750 | 925 | minimal |
| 19 | V | 10 | 750 | 934 | minimal |
| 20 | V | 15 | 750 | 1031 | negligible |
| 21 | V | 15 | 750 | 1003 | negligible |

*including undercut.

### Examples 22-24

### Etching Different Polycarbonate Films

Samples of 7 mil and 10 mil thick polycarbonate film available under the trade designation DE 1-1D from Bayer MaterialScience AG, Pittsburght, Pa., were etched from both sides of the film using different etchant compositions, in beakers placed in water baths at 86° C. without stirring. The etching rates and resist stability for the samples are shown in Table 6.

TABLE 6
Different PC films

| | | | Etching Rate |
|---|---|---|---|
| Ex. | Etchant | Polycarbonate | (umr/min)* |
| 22 | I | DE 1-1D, 7 mil | 38.5 |
| 23 | VI | DE 1-1D, 7 mil | 41.1 |
| 24 | VI | DE 1-1D, 10 mil | 38.0 |

*Etching rate measurement is based on a total etching time of about 2 minutes.

### Examples 25-28

### Etching LCP Films

Samples of 48 um thick liquid crystal polymer (LCP) films available under the trade designation BIAC from Japan Gore-Tex Inc., Okayama-ken, Japan were laminated to 1 8 um thick copper. Patterned etch masks were applied to the films, which were then etched using different etchant compositions in beakers placed in water baths at 86° C. without stirring. The etching rates for the samples are shown in Table 7.

TABLE 7
LCP films

| Ex. | Etchant | Etching time(min)* |
|---|---|---|
| 25 | I | 9 |
| 26 | III | 10 |
| 27 | V | 8 |
| 28 | VII | 5.5 |

*time to etch all the way through the LCP film

### Examples 29-30

### Etching Polyimide Films

Samples of 1 mil thick polyimide film available under the trade designation UPILEX-S from Ube Industries, Tokyo, Japan, film were covered with a 1.5 mil photoresist on each side. The photoresist on one side was then pattern exposed and the photoresist on the other side was flood-exposed. The sample was immersed in an etchant composition for 16 minutes at 86° C. The remaining photoresist was then stripped and the etched features were visually evaluated. The results of the evaluation are provided in Table 8.

TABLE 8
Polyimide films

| Ex. | Etchant | Results |
|---|---|---|
| 29 | I | Almost etched through |
| 30 | IV | Fully etched through |

### Examples 31-33

### Etching PET

Samples of 4 mil thick polyethylene terephthalate (PET) film were etched from both sides of the film using different etchant compositions for 3 minutes in beakers placed in water baths at 86° C. without stirring. The etching rates for the samples are shown in Table 9.

TABLE 9
PET films

| | | Etching |
|---|---|---|
| Ex. | Etchant | rate (um/min)* |
| 31 | I | 6.7 |
| 32 | V | 4.7 |
| 33 | VI | 4.7 |

Various modifications and alterations of this invention will become apparent to those skilled in the art without departing from the scope and spirit of this invention and it should be understood that this invention is not to be unduly limited to the illustrative embodiments set forth herein.

What is claimed is:

1. A composition comprising:
an aqueous solution for etching a polymeric material comprising from about 30 wt. % to about 55 wt. % of an alkali metal salt;
from about 10 wt. % to about 35 wt. % of a solubilizer dissolved in said solution; and from about 3 wt. % to about 30 wt. % ethylene glycol dissolved in said solution.

2. A composition according to claim 1 comprising from about 40 wt. % to about 50 wt. % of said alkali metal salt.

3. A composition according to claim 1 comprising from about 15 wt. % to about 30 wt. % of said solubilizer.

4. A composition according to claim 1 comprising from about 3 wt. % to about 12 wt. % of said ethylene glycol.

5. A composition according to claim 1 comprising about 7 wt. % of said ethylene glycol.

6. A composition according to claim 1 wherein said alkali metal salt is selected from the group consisting of sodium hydroxide and potassium hydroxide.

7. A composition according to claim 1 wherein said solubilizer is an amine.

8. A composition according to claim 1 wherein said solubilizer is ethanolamine.

9. A process comprising:
providing a polymeric film;
contacting said polymeric film with an aqueous solution comprising from about 30 wt. % to about 55 wt. % of an alkali metal salt;
from about 10 wt. % to about 35 wt. % of a solubilizer dissolved in said solution; and
from about 3 wt. % to about 30 wt. % ethylene glycol dissolved in said solution.

10. A process according to claim 9 wherein said aqueous solution comprises from about 40 wt. % to about 50 wt. % of said alkali metal salt.

11. A process according to claim 9 wherein said aqueous solution comprises from about 15 wt. % to about 30 wt. % of said solubilizer.

12. A process according to claim 9 wherein said aqueous solution comprises from about 3 wt. % to about 12 wt. % of said ethylene glycol.

13. A process according to claim 9 wherein said aqueous solution comprises about 7 wt. % of said ethylene glycol.

14. A process according to claim 9 wherein said alkali metal salt is selected from the group consisting of sodium hydroxide and potassium hydroxide.

15. A process according to claim 9 wherein said solubilizer is an amine.

16. A process according to claim 9 wherein said solubilizer is ethanolamine.

17. A process according to claim 9 wherein said polymeric film selected from the group consisting of polyesters, polycarbonates, polyimides, and liquid crystal polymers.

18. A process according to claim 9 wherein said polymeric film is a substrate for a flexible circuit.

19. A process according to claim 9 wherein said polymeric film is a substrate for a microfluidic device.

20. A process according to claim 9 wherein said polymeric film is a substrate for a carrier film.

21. A process according to claim 9 wherein contacting said solution with said polymeric film produces one or more of a through-hole having non-parallel angled walls, a recess, a void, an unsupported cantilevered lead.
